(19) United States
(12) Patent Application Publication
(10) Pub. No.: US 2024/0386429 A1
(43) Pub. Date: Nov. 21, 2024

(54) USING SMART CONTRACTS TO MANAGE EVENT STREAMS

(71) Applicant: International Business Machines Corporation, Armonk, NY (US)

(72) Inventors: Peng Hui Jiang, Beijing (CN); Timo Kussmaul, Boeblingen (DE); Stefan Schmitt, Holzgerlingen (DE); Xiang Dong Hu, Beijing (CN)

(21) Appl. No.: 18/319,544

(22) Filed: May 18, 2023

(51) Int. Cl. G06Q 20/40; G06Q 20/38

(52) U.S. Cl. CPC G06Q 20/405; G06Q 20/38215

(57) ABSTRACT

According to one embodiment, a method, computer system, and computer program product for managing an event stream is provided. The embodiment may include identifying two or more endpoints, including at least one sender and at least one recipient. The embodiment may also include determining one or more exchange rules to govern a stream of messages sent from the at least one sender to the at least one recipient. The embodiment may further include generating a smart contract according to the one or more exchange rules. The embodiment may also include receiving an input message in the stream of messages from the at least one sender. The embodiment may further include in response to receiving the input message, sending an output message to the at least one recipient.

### BACKGROUND

The present invention relates generally to the field of computing, and more particularly to event streaming.

Event streaming is the practice of using or managing a stream, channel, or series of messages or events to facilitate communication or useful transfer of data over time. Using asynchronous interactions in response to events may be an efficient alternative to frequent polling of traditional Application Programming Interfaces (APIs). Event streaming may be used, for example, to manage a series of purchases, messages in a chat room, or notifications on an operating system. Events may communicate with various services and APIs, and may trigger other events, creating a complex interactive network of streams that automate a variety of useful functions on user devices and across the internet.

Event streaming often consists of a large series of interconnected microservices, each of which perform simple functions and depend on one another. Services may provide metering and payment features, such as for paid APIs, or attestation, authentication, and encryption services to securely manage communication between senders and recipients. However, use of a large number of services may create inefficiencies and risks, including security risks and the risks of bugs as some services are upgraded. Reliance on centralized servers may create single points of failure in a complex network of events.

### SUMMARY

According to one embodiment, a method, computer system, and computer program product for managing an event stream is provided. The embodiment may include identifying two or more endpoints, including at least one sender and at least one recipient. The embodiment may also include determining one or more exchange rules to govern a stream of messages sent from the at least one sender to the at least one recipient. The embodiment may further include generating a smart contract according to the one or more exchange rules. The embodiment may also include receiving an input message in the stream of messages from the at least one sender. The embodiment may further include in response to receiving the input message, sending an output message to the at least one recipient.

In a preferred embodiment, the one or more exchange rules include one or more payment rules for the stream of messages.

In a preferred embodiment, the one or more payment rules include at least one rule governing payment using cryptocurrency over a blockchain network.

In a preferred embodiment, the generating is performed automatically based on preferences selected by the at least one sender or the at least one recipient.

In a preferred embodiment, each endpoint in the two or more endpoints is a blockchain wallet on a blockchain.

In a preferred embodiment, the embodiment further authenticates an identity of the at least one sender and the at least one recipient using an attestation feature of the blockchain.

In a preferred embodiment, the attestation feature is a feature to recognize a non-fungible token in a particular wallet on the blockchain.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for managing event streams using smart contracts.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to event streaming. The following described exemplary embodiments provide a system, method, and program product to, among other things, manage an event stream securely through use of a smart contract. Therefore, the present embodiment has the capacity to improve the technical field of event streaming by managing an event stream through rules implemented in a smart contract.

As previously described, event streaming is the practice of using or managing a stream, channel, or series of messages or events to facilitate communication or useful transfer of data over time. Using asynchronous interactions in response to events may be an efficient alternative to frequent polling of traditional Application Programming Interfaces (APIs). Event streaming may be used, for example, to manage a series of purchases, messages in a chat room, or notifications on an operating system. Events may communicate with various services and APIs, and may trigger other events, creating a complex interactive network of streams that automate a variety of useful functions on user devices and across the internet.

Event streaming often consists of a large series of interconnected microservices, each of which perform simple functions and depend on one another. Services may provide metering and payment features, such as for paid APIs, or attestation, authentication, and encryption services to securely manage communication between senders and recipients. However, use of a large number of services may create inefficiencies and risks, including security risks and the risks of bugs as some services are upgraded. Reliance on centralized servers may create single points of failure in a complex network of events. As such, it may be advantageous to, among other things, manage an event stream through smart contracts on a blockchain, providing the event stream with decentralized means to manage such functions as message routing, security, and payments.

According to one embodiment, an event streaming program manages a stream of events. The event streaming program may identify two or more parties or endpoints. The event streaming program may determine exchange rules for an event stream and generate a smart contract according to the exchange rules. Upon receiving a message in a message hub, the event streaming program may send the message to at least one recipient according to the smart contract.

One or more embodiments described above may convey the advantage of reducing reliance on centralized servers for event streaming, so that an event stream no longer suffers from a single point of failure or control. The embodiments may further provide benefits to security through blockchain-related attestation, encryption, and authentication features, or simplify payment processing through blockchain-related features.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

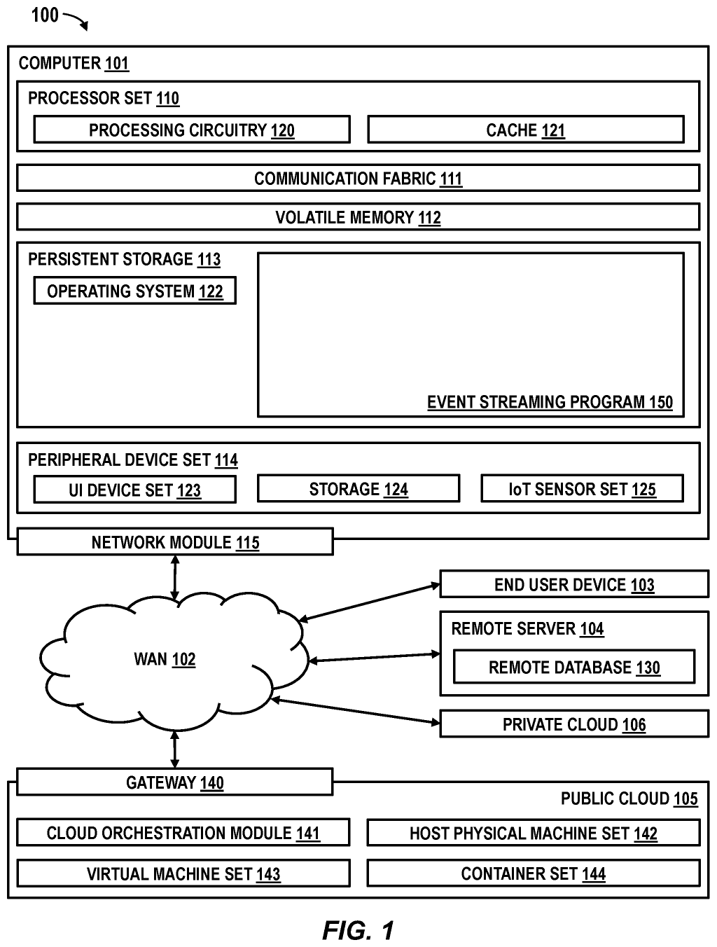

Referring now to FIG. 1, computing environment 100 contains an example of an environment for the execution of at least some of the computer code involved in performing the inventive methods, such as event streaming program 150. In addition to event streaming program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and event streaming program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in event streaming program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in event streaming program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way. EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The event streaming program 150 may identify two or more parties or endpoints, including a sender and a recipient. The event streaming program 150 then determines exchange rules for an event stream, generating a smart contract according to the exchange rules. Upon receiving a message at a message hub, the event streaming program 150 securely sends the message to at least one recipient according to the smart contract.

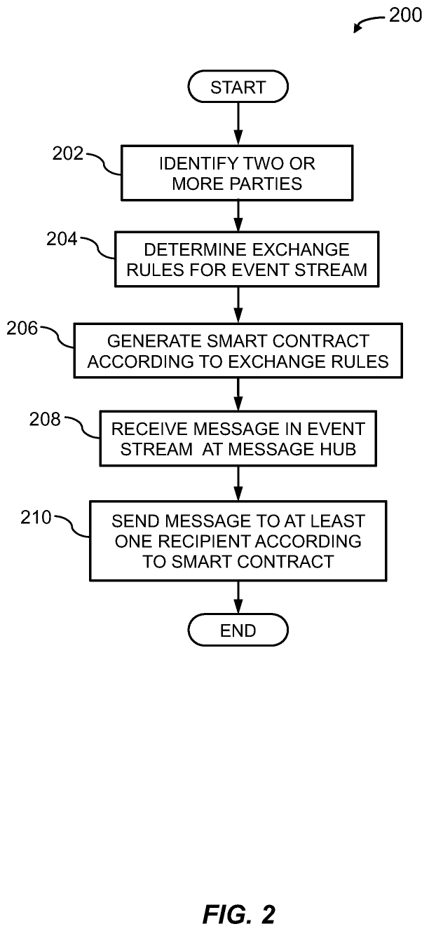

Furthermore, notwithstanding depiction in computer 101, event streaming program 150 may be stored in and/or executed by, individually or in any combination, end user device 103, remote server 104, public cloud 105, and private cloud 106. The event streaming method is explained in more detail below with respect to FIG. 2.

Referring now to FIG. 2, an operational flowchart for a process for managing an event stream through a smart contract 200 is depicted according to at least one embodiment. At 202, the event streaming program 150 identifies two or more parties or endpoints, including at least a sender and a recipient. A party or endpoint may include a physical or virtual device, such as a server, including a message hub server; a person or a user; a legal entity, such as a company; a cryptocurrency wallet; an API endpoint; or a public feed, such as an RSS feed or social media feed.

A party or endpoint may be identified manually. For example, the event streaming program 150 may ask a user, through a graphical user interface, to select a sender or recipient, offering selection of a cryptocurrency wallet, a Uniform Resource Identifier (URI) pointing to a sender, and an option to connect a social media account.

Alternatively, parties and endpoints may be selected automatically. For example, a user may request notifications regarding weather events in a given location, in which case the event streaming program 150 may automatically select a weather API to provide updates regarding the weather. Alternatively, recipients may be all cryptocurrency wallets logged into a client application for the event streaming program 150 that hold a non-fungible token (NFT) signifying participation in the process for managing an event stream through a smart contract 200.

A party or endpoint may be identified as both a sender and recipient. For example, if an event stream consists of a chat room, all parties may be both authorized to send and receive. Alternatively, in the context of a broadcast chat room, all parties may be authorized to receive, but only some parties may be authorized to send. As another alternative, in the context of a social network, all parties may be authorized to send by posting, but each party may manually select a private list of authorized recipients for that party.

In a further embodiment, a message hub may act as a sender or recipient. For example, a message hub may send a message regarding scheduled maintenance downtime for the process for managing an event stream through a smart contract 200, notifying recipients.

Then, at 204, the event streaming program 150 determines exchange rules for an event stream. An event stream may include an input stream of any series of events sent by a sender identified at 202 and received by the event streaming program 150 at 208; an output stream to be sent to a recipient at 210; or any intermediate stream that may be used in the process for managing an event stream through a smart contract 200. Exchange rules may include rules for processing messages or events, payment rules regarding the exchange of messages, rules regarding the security of messages, or any other rules that may be included in a smart contract at 206. Exchange rules may be determined by parties, by a system administrator, or by an automatic process of negotiation.

An input stream may include any series of events sent by a sender identified at 202 and received by the event streaming program 150 at 208, such as each item in an RSS feed, each result of an API polled once per hour, or each message sent by a chat participant. An input stream may be formatted in any way that information may be formatted, and may be encrypted or encoded for authentication, such as with a message authentication code (“MAC”). The event streaming program 150 may identify any number of input streams.

An output stream may include any series of messages to be sent to a recipient at 210. The output stream may be the same set of messages as the input stream, or may be processed or filtered by exchange rules in a variety of ways. For example, if an input stream is a series of 9:00 AM weather reports in Alexandria, VA, an output stream may be a stream of events that sends a message every time the weather report indicates that it will rain. Alternatively, if five input streams each share every article published by a different local newspaper when it is published, an exchange rule may instruct the event streaming program 150 to use artificial intelligence to process the input streams, identify the five most important articles of the week every Friday morning, and send out a digest message every Friday morning to an output stream. An output stream may maintain the encryption or authentication methods of an input stream, decrypt or remove authentication information from the input stream, or re-encrypt or re-authenticate messages for output, all as described below at 210.

In at least one embodiment, an event stream may further include any other stream that may be useful in the process for managing an event stream through a smart contract 200. For example, an event stream may include an intermediate stream used to translate an input stream to another format for processing or output. Additionally, an exchange rule may, in response to a message in an input stream, trigger another event, which may be processed as a new message in an input stream or intermediate stream.

Exchange rules may include payment rules regarding the exchange of messages. For example, exchange rules may include a fee structure that a party must pay in order to send a message, receive a message, or both. Payment rules may also include a refund structure; a preferred unit of currency, including fiat currency, cryptocurrency, or other assets that may be used for payment; or rules regarding escrow. For example, a payment rule may indicate that recipients must commit at least $0.06 worth of cryptocurrency tokens in any of three preselected currencies into a smart contract representing an account in order to receive messages; that, when a recipient receives a message, $0.06 worth of cryptocurrency tokens will be taken from the recipient's account; but that, if a message remains unread by the recipient for five days, the recipient will be refunded $0.04 worth of cryptocurrency to the recipient's account. Fees may be variable, may be calculated by any simple or complex algorithm, and may include a transaction fee such as a cryptocurrency transaction fee or credit card transaction fee. Transactions may be handled by a cryptocurrency network, an abstracted transaction system over a cryptocurrency network such as a “rollup” or “layer 2” solution, or a traditional transaction system, such as a credit card processing facility.

Exchange rules may further include rules regarding the security of messages. For example, exchange rules may include a rule that encryption should be maintained from endpoint to endpoint, i.e. that messages should not be decrypted by the smart contract or message hub. Alternatively, an exchange rule may include checking the input stream should include using blockchain attestation features in order to authenticate the input stream and authenticate recipients, but signing the output stream from a message hub using a traditional MAC. Blockchain attestation features may include, for example, traditional authentication techniques using private and public keys associated with blockchain wallets or authentication of assets such as an NFT, including, for example, an NFT indicating that a recipient has a subscription to an API service. An NFT may further be a non-transferrable or “soulbound” token (SBT). An SBT may, for example, be used to verify the identity of a recipient wallet, or to provide non-transferrable access to a service.

Exchange rules may be determined by one or more parties. For example, if a sender is a newspaper with a regular subscription fee, the newspaper may set the terms of a subscription, and recipients may agree by selecting a subscribe button in a user interface. Alternatively, two sophisticated parties may engage in a secure exchange of an event stream, and may negotiate the terms of the exchange as they would the terms of a contract.

In another embodiment, exchange rules may be set by a system administrator. For example, if the event streaming program 150 is or manages a chat service, a system administrator may determine that all messages in the chat service should be encrypted from endpoint to endpoint using a specific cryptographic protocol.

In yet another embodiment, exchange rules may be set by an automatic process of negotiation. For example, parties may select preferences for an exchange using check boxes, and the event streaming program 150 may select exchange rules based on the preferences selected. Alternatively, the event streaming program 150 may use a process of artificial intelligence and a machine learning model trained on past data collected regarding a similar exchange of information to draft a new set of exchange rules.

Exchange rules may cover an exchange of messages between two parties, from one party to many, from many parties to one, or between a party and a message hub.

The event streaming program 150 may determine more than one set of exchange rules, governing any set of exchanges between any combination of parties, and may modify or redetermine exchange rules at any time. For example, a party may request a change in exchange rules by selecting a preference in a user interface in a client app for the event streaming program 150. A change in exchange rules may trigger generation of a new smart contract at 206.

Next, at 206, the event streaming program 150 generates a smart contract to manage the event stream according to the exchange rules. A smart contract may operate on a blockchain, and may be written in a smart contract programming language, such as Solidity™ (Solidity and all Solidity-based trademarks and logos are trademarks or registered trademarks of the Ethereum Foundation and/or its affiliates). A smart contract may be generated by a human author, by an automatic process, or by a combination thereof.

In at least one embodiment, a smart contract may be written by a human author or programmer, based on the exchange rules. For example, a newspaper may hire an expert Solidity™ programmer to write a smart contract according to the exchange rules determined for subscriptions.

In another embodiment, a smart contract may be automatically generated. For example, if users select preferences in a graphical user interface, such as a preference each party pays 0.00005 ETH per message sent and 0.00005 ETH per message received, that message attestation should be handled by the smart contract using blockchain attestation features, and that messages may contain text, images, and files in any of the formats in a list of formats, the event streaming program 150 may combine pre-written blocks of code into a smart contract that represents the preferences of the parties.

In another embodiment, a smart contract may be generated according to a combination of automatic and human processes. As another example, if the parties determine exchange rules in the form of a legal contract written in the English language, a smart contract may be automatically generated by a process of artificial intelligence, and then reviewed by a human expert smart contract programmer for errors.

The event streaming program 150 may collect feedback regarding smart contracts, including how satisfied the parties are, errors found in smart contracts, and how often smart contracts need to be renegotiated. The event streaming program 150 may further train a machine learning model according to that feedback. Alternatively, the event streaming program 150 may train a machine learning model based on smart contracts written, for example, by expert human programmers, and the set of exchange rules they were written for. This trained machine learning model may be used to assist in generating future smart contracts, such as in the process of artificial intelligence described above.

In another embodiment, the event streaming program 150 may negotiate more than one smart contract. For example, the event streaming program 150 may negotiate several smart contracts to handle several exchanges centered around one message hub system. Alternatively, the event streaming program 150 may use helper smart contracts to handle functions for a main smart contract handling an exchange. For example, a smart contract may refer to another smart contract for handling payments, which may refer to another smart contract for handling escrow. A smart contract may delegate any function to any other smart contract or non-smart-contract module, including a message hub, an attestation module, a payment module, a rule module, a random number generator, a time API, or any other service or module.

The event streaming program 150 may generate a new smart contract, or renegotiate an existing smart contract, upon request of the users, upon finding a bug, error, risk, or inefficiency in a previous contract, upon noting a change in the exchange rules, or at any other time.

Then, at 208, the event streaming program 150 receives a message as input. An input message may be part of an input stream, and may be received at a message hub. A message hub may be a centralized server or virtual server, a blockchain network, or the smart contract itself. An input message may represent an event. The event streaming program 150 may, in response to receiving a message, process the message, trigger another event as described at 204, or send a message at 210. Receiving a message may include authenticating the sender, handling attestation for the sender, processing a payment, or decrypting the message.

An input message may represent an event. For example, an input message may be sent to the event streaming program 150 by a service that monitors the weather upon recognizing a weather event. Alternatively, a server may send a message to the event streaming program 150 when its heat exceeds a predetermined level, requiring attention of a system administrator. As another alternative, a credit card company may send a message to the event streaming program 150 when a potential fraud is detected on a card holder's account.

In at least one embodiment, the event streaming program 150 receives a message at a message hub. A message hub may be a centralized physical server or a virtual server. A message hub may manage intake of messages, store messages, process messages, or send messages as at 210, all according to the exchange rules and the smart contract. Alternatively, a message hub may be represented by a blockchain network or a smart contract itself. For example, a smart contract may, upon receiving a message, store the message in an object on a blockchain, such as an NFT.

In response to receiving a message, the event streaming program 150 may, process the message or trigger another event, as described at 204, or send a message, as described at 210. The input message may be routed directly to an output stream, or may be filtered, translated, or otherwise processed. For example, a message hub may, upon receiving a message consisting of a vote for a candidate in a college club election, add the vote to a tally, and maintain that tally until the predetermined time the election is meant to end. The message hub may then recognize the end of the election as an event, and, upon receiving the event for the end of the election, send the tally to an election chair.

In at least one embodiment, the event streaming program 150 may, upon receiving a message from a sender, charge the sender according to the payment rules of a smart contract. The event streaming program 150 may further process a payment, including a refund, a system of escrow, or other payment services, such as invoicing, credit, or insurance.

In another embodiment, the event streaming program 150 may use various methods to authenticate the sender. Authentication may include traditional methods of authentication, including a MAC or a secure session with a user account, or blockchain-specific methods of authentication and attestation, including methods that involve signed transactions, public and private keys of a blockchain wallet, or recognition of certain assets in a blockchain wallet, such as an NFT or SBT representing a certain status as a sender. For example, a private membership club may allow only people with a club member NFT to send messages.

In a further embodiment, the event streaming program 150 may decrypt an encrypted message. Alternatively, the event streaming program 150 may maintain the existing encryption of an incoming encrypted message.

The event streaming program 150 may receive any number of messages from any number of senders. For example, the event streaming program 150 may receive two hundred separate event streams from one sender intended for each of two hundred recipients.

A sender may send a message through an algorithmic process, through an end user application, or by any other method.

Next, at 210, the event streaming program 150 sends a message to at least one recipient according to the smart contract. Sending a message may include determining the proper recipients, handling attestation for the recipient, processing a payment, or encrypting the message. Messages may be sent from a message hub, or any server or smart contract. A series of one or more messages may comprise an output stream of messages.

Sending a message may include determining the proper recipients according to the smart contract. A message may be sent to any number of recipients, may be sent multiple times. The event streaming program 150 may send the message to a recipient immediately, or schedule a message to send at a particular time, either according to a rule in a smart contract or a user preference. Determining the proper recipient may include authenticating the recipient's or engaging in attestation using blockchain features as described above.

Sending a message may further include processing a payment, including by charging the sender or recipient, processing a refund, handling escrow, or engaging in other payment services, such as invoicing, credit, or insurance. For example, processing a payment may include using a third-party credit service to receive payment and on credit of the recipient.

In yet another embodiment, sending a message may include encrypting the message, or adding a MAC to authenticate the message. Alternatively, sending a message may include preserving the original encryption of the message, or decrypting the original message and encrypting it according to a new encryption protocol or new encryption keys.

Messages may be sent from a message hub, or any server or smart contract. A message hub may be a centralized server, virtual server, blockchain network, or smart contract. Alternatively, a message may be sent directly from a sender to a recipient over a network according to a smart contract without being routed through an intermediate server or hub.

Sending a message to a recipient may include sending a message through any number of media or to any number of devices or applications associated with a recipient. For example, if a recipient is a company's research department, sending a message may include sending the message to the e-mail address of each person in the department and sending a notification through a phone operating system's notification messaging API to each person in the department's phone.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying two or more endpoints, including at least one sender and at least one recipient;
determining one or more exchange rules to govern a stream of messages sent from the at least one sender to the at least one recipient;
generating a smart contract according to the one or more exchange rules;
receiving an input message in the stream of messages from the at least one sender; and
in response to receiving the input message, sending an output message to the at least one recipient.

2. The method of claim 1, wherein the one or more exchange rules include one or more payment rules for the stream of messages.

3. The method of claim 2, wherein the one or more payment rules include at least one rule governing payment using cryptocurrency over a blockchain network.

4. The method of claim 1, wherein the generating is performed automatically based on preferences selected by the at least one sender or the at least one recipient.

5. The method of claim 1, wherein each endpoint in the two or more endpoints is a blockchain wallet on a blockchain.

6. The method of claim 5, further comprising:
authenticating an identity of the at least one sender and the at least one recipient using an attestation feature of the blockchain.

7. The method of claim 6, wherein the attestation feature is a feature to recognize a non-fungible token in a particular wallet on the blockchain.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying two or more endpoints, including at least one sender and at least one recipient;
determining one or more exchange rules to govern a stream of messages sent from the at least one sender to the at least one recipient;
generating a smart contract according to the one or more exchange rules;
receiving an input message in the stream of messages from the at least one sender; and
in response to receiving the input message, sending an output message to the at least one recipient.

9. The computer system of claim 8, wherein the one or more exchange rules include one or more payment rules for the stream of messages.

10. The computer system of claim 9, wherein the one or more payment rules include at least one rule governing payment using cryptocurrency over a blockchain network.

11. The computer system of claim 8, wherein the generating is performed automatically based on preferences selected by the at least one sender or the at least one recipient.

12. The computer system of claim 8, wherein each endpoint in the two or more endpoints is a blockchain wallet on a blockchain.

13. The computer system of claim 12, further comprising:
authenticating an identity of the at least one sender and the at least one recipient using an attestation feature of the blockchain.

14. The computer system of claim 13, wherein the attestation feature is a feature to recognize a non-fungible token in a particular wallet on the blockchain.

15. A computer program product, the computer program product comprising:
one or more computer-readable tangible storage medium and program instructions stored on at least one of the one or more tangible storage medium, the program instructions executable by a processor capable of performing a method, the method comprising:
identifying two or more endpoints, including at least one sender and at least one recipient;
determining one or more exchange rules to govern a stream of messages sent from the at least one sender to the at least one recipient;
generating a smart contract according to the one or more exchange rules;
receiving an input message in the stream of messages from the at least one sender; and
in response to receiving the input message, sending an output message to the at least one recipient.

16. The computer program product of claim 15 wherein the one or more exchange rules include one or more payment rules for the stream of messages.

17. The computer program product of claim 16, wherein the one or more payment rules include at least one rule governing payment using cryptocurrency over a blockchain network.

18. The computer program product of claim 15, wherein the generating is performed automatically based on preferences selected by the at least one sender or the at least one recipient.

19. The computer program product of claim 15, further comprising:
authenticating an identity of the at least one sender and the at least one recipient using an attestation feature of a blockchain.

20. The computer program product of claim 19, wherein the attestation feature is a feature to recognize a non-fungible token in a particular wallet on the blockchain.
